(19) United States
(12) Patent Application Publication
(10) Pub. No.: US 2005/0036282 A1
(43) Pub. Date: Feb. 17, 2005

(54) Computer system with monitor for accommodating a user

(76) Inventor: Samuel A. Hardage, Rancho Santa Fe, CA (US)

Correspondence Address: Neil K. Nydegger;NYDEGGER & ASSOCIATES, 348 Olive Street, San Diego, CA, 92103, US

(21) Appl. No.: 10/641,429

(22) Filed: Aug. 15, 2003

(51) Int. Cl. G06F 1/16

(52) U.S. Cl. 361/683; 312/223.3

(57) ABSTRACT

A positioning system for anatomically accommodating a person during typing on a keyboard or viewing a monitor includes a base member, a computer monitor, a keyboard and an adjustable mount. The adjustable mount has a first end and a second end. Specifically, the adjustable mount includes a pole, a first extension arm, a second extension arm, and a tilter mechanism. The system also includes a pole housing, which is attached to the base member and is engageable with the first end of the adjustable mount. The computer monitor rests upon the second end of the adjustable mount. The computer monitor and keyboard are electronically connected. In operation, the user preselects a precise location for the monitor. The system operates to anatomically accommodate the user by allowing the user to substantially move the monitor to the predetermined location.

### FIELD OF THE INVENTION

The present invention pertains generally to methods and systems for selectively positioning a computer monitor. More particularly, the present invention pertains to an adjustable mount for selectively positioning a computer monitor. The present invention is particularly, but not exclusively, useful as a system and method for anatomically accommodating the task of typing on a keyboard while simultaneously facilitating the act of viewing a monitor at a predetermined location.

### BACKGROUND OF THE INVENTION

The task of typing on a computer keyboard while simultaneously viewing a computer monitor requires that the keyboard be at a location within the user's reach, and that the monitor be at a location in the user's effective field of vision. To achieve both of these conditions, the user must be able to move the keyboard and the monitor to respective predetermined points in space. Insofar as a user's field of vision is concerned, once the keyboard has been properly positioned, some users may have a desire or need to view a monitor that is located as close as possible to the face of the user.

Typically, a desktop computer system will include a monitor with a base which the user can place on a flat surface such as a desk. These conventional computer systems do not normally permit the monitor to move in the horizontal or vertical planes between the user and the base of the monitor. In addition, these systems do not permit the monitor to be tilted through a wide angular range. Consequently, such computer systems may not always provide the user with an opportunity to move the monitor to a predetermined location that will accommodate his or her individual set of requirements or desires.

In light of the above, an object of this invention is to provide the user with a computer system for positioning a monitor so that the user is anatomically accommodated when they are typing and viewing a monitor. Another object of the present invention is to provide a system having a monitor that the user may rotate and tilt to a predetermined location relative to the keyboard and the user. It is a further object of this invention to provide a system that permits a monitor to be moved to a predetermined location in a horizontal plane. Another object of this invention is to provide a system that permits a monitor to be moved to a predetermined location in a vertical plane. Still another object of the present invention is to provide a system which is easy to implement, simple to use and comparatively cost effective.

### SUMMARY OF THE INVENTION

The present invention pertains to a system for selectively positioning a computer monitor at a predetermined point in space to anatomically accommodate a user while typing on a keyboard and viewing a computer monitor. In overview, the system includes a base member, a keyboard and an adjustable mount for mounting a monitor on the base member. In detail, the base member acts as a surface for supporting the keyboard and provides a point for securing a first end of the adjustable mount to the base member. Additionally, the computer monitor is attached to the adjustable mount at its second end and is electronically connected to the computer keyboard.

For reference purposes, the adjustable mount defines three axes of rotation for the selective rotation of the monitor relative to the keyboard and base member. With this in mind, the adjustable mount includes a pole that has its first end attached to the base member. When so attached, the pole defines a first axis of rotation that is substantially perpendicular to the base member. The adjustable mount also includes a first extension arm which has a first end that is slidingly mounted on the pole. When so mounted, the first extension arm is substantially perpendicular to the pole. Within this arrangement, the user may adjust the height of the monitor by sliding the extension arm upwardly or downwardly along the pole. Also, the first extension arm is able to rotate freely in a clockwise or counterclockwise direction around the first axis of the system. The height of the monitor is thereby substantially limited to the height of the pole. A collar and a set screw are provided at the first end of the first extension arm to secure the arm to the pole after a position has been selected.

A first end of a second extension arm is attached to the second end of the first extension arm. More specifically, this connector between the first and second extension arms defines the second axis of rotation and positions it with an orientation that is substantially parallel to the first axis. The second arm then extends substantially perpendicular to the second axis and it rotates freely in a clockwise or counterclockwise direction around the second axis. Thus, in combination, the second axis and the first axis allow the user to position the free (second) end of the second extension arm at a desired distance from the first axis. This combination of axes also allow for an angle of rotation that is measured about the first axis. Together, the desired distance from the first axis and the angle rotating about the first axis establish a desired predetermined spatial orientation for the monitor.

In addition to its other rotations mentioned above, the monitor is also rotatably connected to the second end of the second arm to define the third axis of rotation. Specifically, this third axis has an orientation that is substantially perpendicular to the first and second axes. Thus, the user may tilt the monitor at an angle β about the third axis to further refine the desired spatial orientation. In the operation of the present invention, the adjustable mount permits the user to selectively move the monitor in rotation about the three axes to a predetermined point in space. The purpose, of course, is to anatomically accommodate the user's viewing of the monitor while typing on the keyboard.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of the monitor positioning system of the present invention while being used by a user;

FIG. 2 is a top view of the monitor positioning system of the present invention;

FIG. 3A is a schematic view showing the relationship between the three axes of the present invention;

FIG. 3B is a coordinate system describing a preselected distance (d) from the monitor to a point on the base member of the system, the angle of rotation (α) of the system, and the tilt angle (β) of the system; and

FIG. 4 is a side view of an alternative embodiment of the monitor positioning system.

### DESCRIPTION OF THE PREFERRED EMBODIMENTS

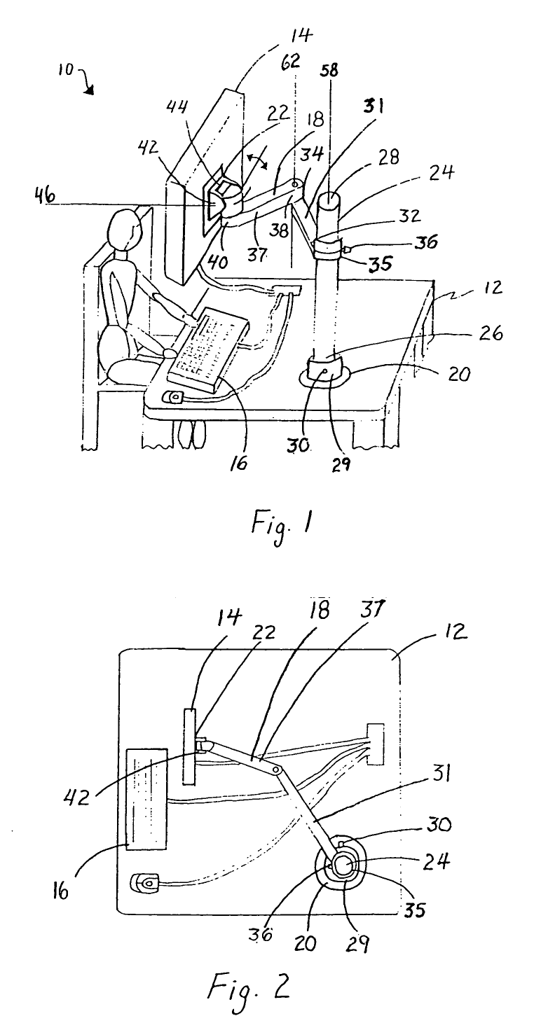

Referring initially to FIG. 1, a system in accordance with the present invention is shown and is generally designated 10. In detail, the system 10 is shown to include a base member 12. Resting on top of the base member 12 is a keyboard 16 for generating data. The keyboard 16 is electronically connected to a monitor 14. As specifically envisioned for the present invention, the monitor 14 is connected to an adjustable mount 18.

As shown, the adjustable mount 18 has a first end 20 and a second end 22. The adjustable mount 18 includes a pole 24 having a first end 26 and a second end 28. As indicated in FIG. 1, the pole 24 connects to a pole housing 29 which secures the pole 24 to the base member 12 by means of a set screw 30. The system 10 has a first extension arm 31 that is slidingly connected to the pole 24 and which has a first end 32 and a second end 34. The first extension arm 31 rests upon a collar 35 that is fastened to the pole 24 by means of a thumbscrew 36 which is located on the collar 35. The system 10 also has a second extension arm 37 which has a first end 38 and a second end 40. It is to be appreciated that the first extension arm 31 and the second extension arm 37 are connected at the second end 34 of the first extension arm 31 and the first end 38 of the second extension arm 37. In addition, the second extension arm 37 attaches to a tilter mechanism 42 at the second end 40 of the second extension arm 37 and the first end 44 of the tilter mechanism 42. The second end 46 of the titter mechanism 42 connects to the monitor 14.

Turning now to FIG. 2, the system 10 is shown in a top view. There it may be appreciated that the monitor 14 may be placed in many locations relative to the keyboard 16. In this particular view, the first extension arm 31 and the second extension arm 37 are only partially extended away from the first end 20 of the adjustable mount 18.

FIG. 3A shows a schematic view of the relationship between the three axes of rotation that are created by the mount 18 of the present invention. The first axis 58 is substantially perpendicular to the base member 12. This first axis 58 provides an axis for rotating the monitor 14 at a preselected angle of rotation 60 within a range of 360 degrees. The first axis 58 remains stationary during the rotation of the monitor 14 and is defined by the pole 24. The connection between the first extension arm 31 and the second extension arm 37 define the second axis 62 that is parallel to the first axis 58. The second axis 62 provides an additional angle of rotation 64 for positioning the monitor 14 at a preselected point.

Still referring to FIG. 3A, it can be seen that the user may tilt the monitor 14 about the third axis 66 at an angle of tilt (β) 68. The third axis 66 structure is defined by the tilter mechanism 42 that is fixedly attached to the second end 40 of the second extension arm 37. This third axis 66 is substantially perpendicular to both the first axis 58 and the second axis 62.

The positioning of the monitor 14 is perhaps best shown in FIG. 3B. As shown, the desired position of the monitor 14 is depicted in terms of a preselected distance (d) from the monitor 14 to a point on the base member 12 of the system 10, in combination with the angle of rotation (α) and the tilt angle (β) of the system 10. More specifically, the distance “d” is established by rotation of the first extension arm 31 about the first axis 58 through the angle 60 and the rotation of the second extension arm 37 about the second axis 62 through an angle 64.

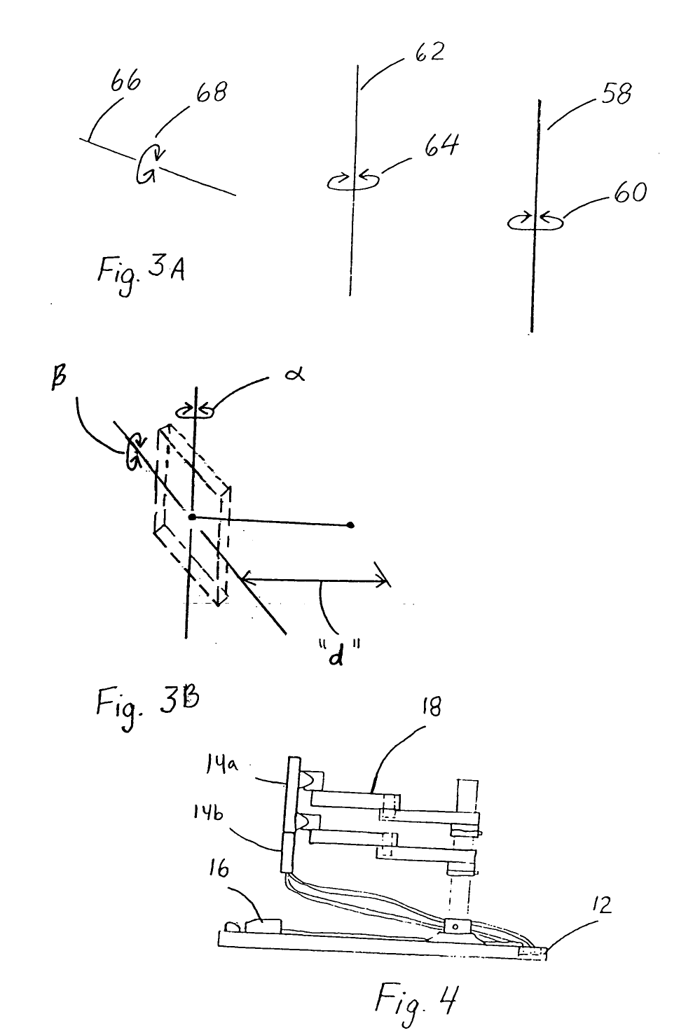

While there are many alternative embodiments contemplated for this invention by this disclosure, FIG. 4 shows one alternative embodiment of the positioning system 10 wherein the user may view and predetermine the position for two separate monitors, shown as 14a and 14b, relative to one keyboard 16. FIG. 4 illustrates that both monitors, 14a and 14b may have the same tilt angle (β) and each monitor 14a and 14b may be positioned at a unique angle of rotation (α).

While this particular system as herein shown and disclosed in detail is fully capable of obtaining the objects and providing the advantages herein before stated, it is to be understood that it is merely illustrative of the presently preferred embodiments of the invention and that no limitations are intended to the details of the construction or design herein shown other than as described in the appended claims.

1. A system for anatomically accommodating a user during the use of a computer, said system comprising:
a base member having a surface;
a monitor;
a keyboard which is electronically connected to said monitor; and
an adjustable mount having a first end and a second end, with said first end of said adjustable mount attached to said base member and said second end of said adjustable mount attached to said monitor, wherein said adjustable mount defines a first axis substantially perpendicular to said surface of said base member, a second axis that is substantially parallel to the first axis, and a third axis that is substantially perpendicular to the second axis to provide for selective rotation of said monitor about the first, second and third axes to position said monitor relative to said keyboard to anatomically accommodate the simultaneous viewing of said monitor and typing on said keyboard by the user.

2. A system as recited in claim 1 wherein said adjustable mount comprises:
a pole having a first end and a second end defining the first axis;
a first extension arm having a first end slidingly mounted on said pole for reciprocating movement along the first axis, and said first extension arm having a second end positioned on the second axis; and
a second extension arm having a first end positioned on the second axis and a second end positioned on the third axis.

3. A system as recited in claim 2 further comprising a tilter mechanism having a first and second end, with said first end of said tilter mechanism positioned on said monitor and said second end positioned on said second end of said second extension arm of said adjustable mount.

4. A system as recited in claim 3 further comprising a collar, wherein said collar is slidingly mounted on said pole and has a thumbscrew wherein said thumbscrew is threadably engageable with said collar.

5. A system as cited in claim 4 further comprising:
a plurality of said first extension arms; and
a plurality of said second extension arms.

6. A system for anatomical accommodation during the use of a computer, said system comprising:
a base member having a surface;
a monitor;
a means for generating data, said generating means being electronically connected to said monitor for the transmission of data to said monitor for the display of data thereon; and
an adjustable means for positioning said monitor in a predetermined orientation relative to a point on the surface of said base member, wherein said adjustable means has a first end and a second end with the first end of said adjustable means attached to the surface of said base member at the point, and with said second end of said adjustable means attached to said monitor, with said adjustable means being reconfigurable to orient said monitor at a preselected distance (d) from the point at a preselected angle of tilt (α), and angle of rotation (β).

7. A system as recited in claim 6 wherein said adjustable means includes an adjustable mount comprising a pole having a first end and a second end, a first extension arm having a first end slidingly mounted on said pole to orient said monitor at a preselected distance (d) from the point on said surface of said base member, and a second extension arm attached to said first extension arm to orient the monitor at a preselected distance (d) from the point on said surface of said base member.

8. A system as recited in claim 7 wherein said adjustable means further comprises:
a collar having a predetermined location on said pole, and a tilter mechanism attached to said second extension arm, said tilter mechanism being connected to said monitor and tiltable to a preselected angle of tilt (β).

9. A system as recited in claim 8 wherein said first end of said tilter mechanism includes a cylindrical shaft adapter, and wherein said cylindrical shaft adapter is engageable with said second extension arm.

10. A method for using the computer system which comprises the steps of:
providing a computer system including a base member having a surface, a monitor, a keyboard electronically connected to said monitor, and an adjustable mount having a first end and a second end, with the first end of said mount attached to said base member and the second end of said mount attached to said computer monitor, wherein said adjustable mount defines a first axis substantially perpendicular to the surface of said base member, a second axis that is substantially parallel to the first axis, and a third axis that is substantially perpendicular to the second axis, to provide for selective rotation of said computer monitor about the first, second and third axes to position said computer screen relative to said keyboard to anatomically accommodate simultaneous viewing of said computer monitor and typing on the keyboard by the person; and
positioning said monitor in a predetermined orientation relative to a point on said surface of said base member.

11. A method as recited in claim 10 wherein said adjustable mount comprises:
a pole having a first end and a second end defining the first axis;
a first extension arm having a first end slidingly mounted on said pole for reciprocating movement along the first axis, and said first extension arm having a second end positioned on the second axis;
a second extension arm having a first end positioned on the third axis; and
a tilter mechanism having a first and second end, wherein said first end is positioned on said monitor and said second end is positioned on the third axis.

12. A method as recited in claim 11 wherein said adjustable mount further comprises a means for stabilizing said first end of said adjustable mount, wherein said means for stabilizing comprises a pole housing, wherein said pole housing is fixedly attached to said surface of said base member and wherein said pole housing has a hollow cavity, said hollow cavity having internal threading for threadable engagement with said pole.

13. A method as recited in claim 12 wherein said adjustable mount further comprises a tilter mechanism, wherein said tilter mechanism further comprises a cylindrical shaft adapter, wherein said cylindrical shaft adapter is engageable with said second extension arm.

14. A method as recited in claim 13 further comprising the step of storing cables of said system within said first extension arm and within said second extension arm, wherein said first extension arm has an internal compartment and said second extension arm has an internal compartment.

15. A method as recited in claim 11 wherein said adjustable mount further comprises a plurality of first extension arms and a plurality of second extension arms to accommodate a system having multiple screens.
